(19) United States
(12) Patent Application Publication
(10) Pub. No.: US 2024/0083426 A1
(43) Pub. Date: Mar. 14, 2024

(54) CONTROL CALCULATION APPARATUS AND CONTROL CALCULATION METHOD

(71) Applicant: Mitsubishi Electric Corporation, Tokyo (JP)

(72) Inventors: Ryota OKAMOTO, Tokyo (JP); Tomoki UNO, Tokyo (JP)

(73) Assignee: Mitsubishi Electric Corporation, Tokyo (JP)

(21) Appl. No.: 18/269,356

(22) PCT Filed: Feb. 9, 2021
(86) PCT No.: PCT/JP2021/004808

§ 371 Date: Jun. 23, 2023

(51) Int. Cl. B60W 30/10; B60W 40/10; B60W 50/00

(52) U.S. Cl. CPC B60W 30/10; B60W 40/10; B60W 50/0097; B60W 2050/0022; B60W 2520/10; B60W 2552/30

(57) ABSTRACT

A control calculation apparatus (42) includes a target-trajectory generation section (421) that generates a target trajectory including a target route (T1) for a vehicle (40), based on information around the vehicle (40); a prediction time period setting section (422) that sets a prediction time period for predicting states of the vehicle (40), based on the target route (T1); and a control calculation section (423) that calculates target control values for making the vehicle (40) keep track of the target trajectory in the prediction time period, and then outputs the target control values to a control section (5) that controls the vehicle (40).

### TECHNICAL FIELD

The present disclosure relates to a control calculation apparatus and a control calculation method that calculate target control values for controlling a vehicle in automatic driving.

### BACKGROUND ART

In recent years, automatic driving of a vehicle has been put into practical use, and there has been proposed a technology that is related to target-trajectory generation and target-control-value calculation to which model prediction control is applied.

Patent document 1 discloses a control apparatus that calculates target control values for preventing collision between a vehicle and an obstacle around the vehicle, through model prediction control.

### CITATION LIST

### Patent Literature

Patent document 1: JP-A-2020-52810

### SUMMARY OF INVENTION

### Technical Problem

In model prediction control, future vehicle states during a preliminarily set prediction time period are predicted and then target control values are calculated so that the states keep track of a target trajectory. In the case where a route for avoiding an obstacle is complicated, the vehicle tends to have a low vehicle velocity in order to safely perform automatic driving. However, when the prediction time period is a preliminarily set fixed value, a predicted distance, i.e., a predicted amount cannot sufficiently be secured. In Patent document 1, it is not considered change a prediction time period; thus, in the case of such a complicated route as described above, a predicted amount cannot sufficiently be secured and hence there is posed a problem that no target control value can accurately be calculated.

The present disclosure has been implemented in order to solve the foregoing problem; the objective thereof is to provide a control calculation apparatus and a control calculation method that accurately calculate target control values even on a complicated route.

### Solution to Problem

A control calculation apparatus according to the present disclosure includes:

a target-trajectory generation section that generates a target trajectory including a target route for a vehicle, based on information around the vehicle, a prediction time period setting section that sets a prediction time period for predicting states of the vehicle, based on the target route, and a control calculation section that calculates target control values for making the vehicle keep track of the target trajectory in the prediction time period, and then outputs the target control values to a control section that controls the vehicle.

A control calculation method according to the present disclosure includes:
generating a target trajectory including a target route for a vehicle, based on information around the vehicle,
setting a prediction time period for predicting states of the vehicle, based on the target route, and
calculating target control values for making the vehicle keep track of the target trajectory in the prediction time period and then outputting the target control values to a control section that controls the vehicle.

### Advantage of Invention

Because in the control calculation apparatus and the control calculation method according to the present disclosure, the prediction time period is set based on the target route, the predicted amount can sufficiently be secured even in the case of a complicated route; thus, the target control values can accurately be calculated.

### BRIEF DESCRIPTION OF THE DRAWINGS

FIG. 1 is a block diagram representing an example of a control calculation apparatus according to Embodiment 1;

FIG. 2 is a set of graphs representing an example of the relationship between a road curvature and a prediction time period according to any one of Embodiments 1 and 2;

FIG. 3 is an explanatory chart representing an example of a method of setting a predicted-amount lower limit value according to any one of Embodiments 1 and 2;

FIG. 4 is a graph representing an example of the relationship between a target-control-value calculation period and a prediction interval according to any one of Embodiments 1 and 2;

FIG. 5 is a flowchart representing an example of a procedure from target-trajectory generation to target-control-value outputting according to Embodiment 1;

FIG. 6 is a simulation result representing an example of a vehicle traveling trajectory for a target route according to Embodiment 1;

FIG. 7 is a block diagram representing an example of a control calculation apparatus according to Embodiment 2;

FIG. 8 is a flowchart representing an example of a procedure from target-trajectory generation to target-control-value outputting according to Embodiment 2; and

FIG. 9 is a diagram representing the hardware configuration of each of a vehicle-state acquisition section, a control calculation apparatus, and a control section according to any one of Embodiments 1 and 2.

### DESCRIPTION OF EMBODIMENTS

### Embodiment 1

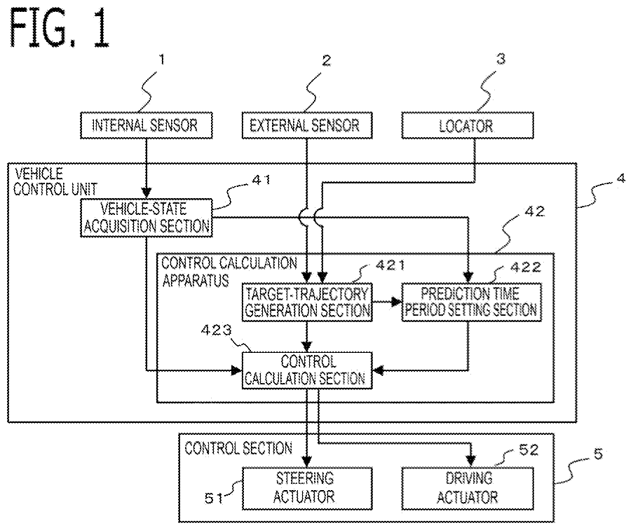

FIG. 1 is a block diagram representing an example of a control calculation apparatus 42 according to Embodiment 1. FIG. 1 is a block diagram including an internal sensor 1, an external sensor 2, a locator 3, a vehicle-state acquisition section 41, the control calculation apparatus 42, and a control section 5. Based on information from the internal sensor 1 and information from the external sensor 2, the control calculation apparatus 42 calculates target control values for controlling a vehicle 40 and then outputs the target control values to the control section 5. In this situation, the target control values are a target steering amount and a target acceleration/deceleration amount.

The internal sensor 1 is provided in the vehicle 40 and outputs information related to the vehicle 40. The internal sensor 1 is, for example, a steering angle sensor, a steering torque sensor, a yaw-rate sensor, a vehicle velocity sensor, an acceleration sensor, or the like.

The external sensor 2 is provided in the vehicle 40 and outputs information around the vehicle 40. The external sensor 2 is, for example, a front camera for detecting the position and the angle of a road lane line, a radar for acquiring the position and the velocity of a preceding vehicle, a LiDAR (Light Detection and Ranging) apparatus, a sonar, an inter-vehicle communication apparatus, a road-vehicle communication apparatus, or the like. The information around the vehicle 40 is, for example, the position and the velocity of another vehicle, a bicycle, a pedestrian, or the like.

Based on the map information and the position of the vehicle 40, the locator 3 outputs map information on a place where the vehicle 40 should travel. The locator 3 may include either a LiDAR apparatus and map data or a GNSS and map data.

Based on information from the internal sensor 1, the vehicle-state acquisition section 41 acquires the present values of the states of the vehicle 40. The states are the position and the velocity of the vehicle 40 and the like.

The control calculation apparatus 42 has a target-trajectory generation section 421, a prediction time period setting section 422, and a control calculation section 423.

Based on information around the vehicle 40 from the external sensor 2, the target-trajectory generation section 421 generates a target trajectory including a target route T1 of the vehicle 40. The target route T1 is point-sequence information on a target position; the point-sequence information may include time information or may not include any time information. In contrast, the target trajectory includes respective point-sequence information pieces on a target position, a target velocity, and the like; the point-sequence information includes time information. The target trajectory is generated based on the target route T1 and a vehicle movement model. The target-trajectory generation section 421 outputs the target route T1 to the prediction time period setting section 422 and a target trajectory to the control calculation section 423.

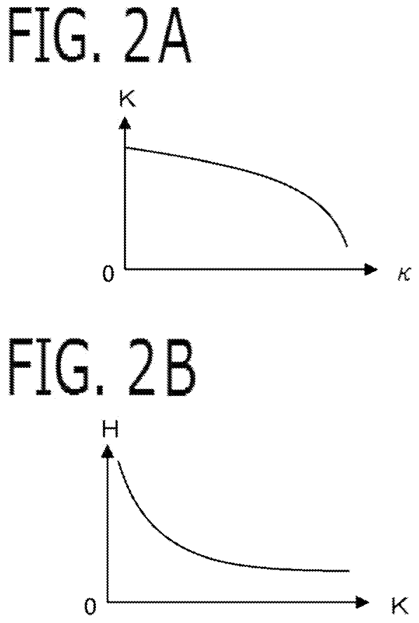

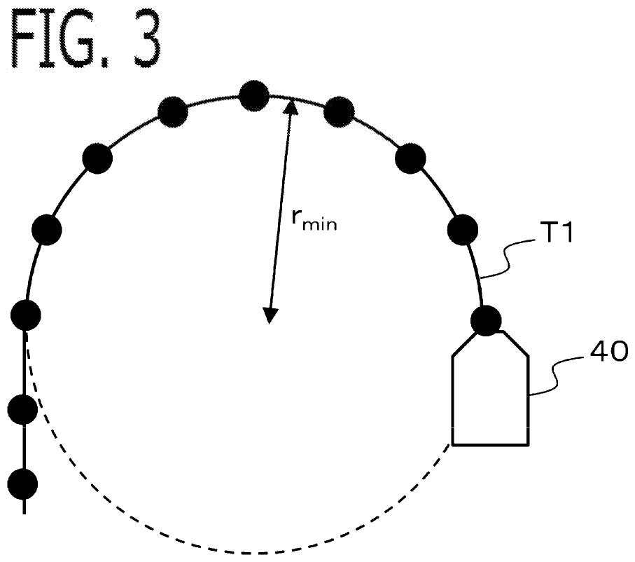

Based on the target route T1 from the target-trajectory generation section 421, the prediction time period setting section 422 sets a prediction time period for predicting the states of the vehicle 40. Alternatively, the prediction time period setting section 422 sets the prediction time period, based on the target route T1 and the present values of the states of the vehicle 40 from the vehicle-state acquisition section 41. In this situation, the state of the vehicle 40 denotes the velocity thereof. That is to say, the prediction time period setting section 422 sets the prediction time period, based on the target route T1 and the present value of the velocity in the states of the vehicle 40. The prediction time period signifies a time period when the states are predicted in a time period ranging from the present to the future, and is expressed by time. The method in which the prediction time period setting section 422 sets a prediction time period, based on the target route T1, will be explained in detail by use of FIG. 2, later. In addition, the method in which the prediction time period setting section 422 sets a prediction time period, based on the target route T1 and the present values of the states of the vehicle 40, will be explained in detail by use of FIG. 3, later.

By use of a prediction time period to be set in the prediction time period setting section 422, the control calculation section 423 calculates target control values for making the vehicle 40 keep track of the target trajectory in the prediction time period, and then outputs the target control values to the control section 5 that controls the vehicle 40. The control calculation section 423 outputs the target steering amount among the target control values to a steering actuator 51 and outputs the target acceleration/deceleration amount among the target control values to a driving actuator 52. The control calculation section 423 will be explained in detail, later.

In addition, although not specified here, the area of a target trajectory to be generated by the target-trajectory generation section 421 may be the same as the area of the target trajectory to be utilized when target control values are calculated by the control calculation section 423, i.e., the prediction time period to be set by the prediction time period setting section 422. As a result, the calculation load at a time when the target-trajectory generation section 421 generates a target trajectory can be reduced.

In the present embodiment, the vehicle control unit 4 includes the vehicle-state acquisition section 41 and the control calculation apparatus 42. The vehicle control unit 4 is, for example, an ADAS-ECU (Advanced Driver Assistance System-Electronic Control Unit) or the like.

The control section 5, which is a controller, as an external apparatus of the vehicle control unit 4, mounted in the vehicle 40, makes the actuators operate so that the vehicle 40 keeps track of the target control values from the control calculation section 423. The control section 5 includes the steering actuator 51 and the driving actuator 52.

The steering actuator 51 is provided with, for example, a motor for EPS (Electric Power Steering) and an ECU (Electronic Control Unit). The steering actuator 51 can control the respective rotations of the steering wheel and the front wheels by operating in accordance with a target steering amount from the control section 5.

The driving actuator 52 includes, for example, a vehicle driving apparatus for driving the vehicle 40 in the longitudinal direction and a brake-controlling apparatus for braking the vehicle 40. The steering actuator 52 can control the respective rotations of the front wheels and the rear wheels by operating in accordance with a target acceleration/deceleration amount from the control section 5.

Next, the method in which the prediction time period setting section 422 sets a prediction time period, based on the target route T1, will be explained by use of FIG. 2.

FIGS. 2(a) and 2(b) are graphs representing an example of the relationship between a road curvature and a prediction time period according to Embodiment 1. FIG. 2(a) is a graph representing an example of the relationship between a road curvature κ and a variable K. FIG. 2(b) is a graph representing an example of the relationship between the variable K and a prediction time period H.

As represented in FIG. 2, the prediction time period setting section 422 sets the prediction time period H, based on the road curvature κ to be calculated from the target route T1. The relationship between the curvature κ and the variable K is expressed by the equation (1) below.

$$K = \frac{1}{1 + {e}^{A κ - B}} \qquad ( 1 )$$

In the equation (1), A and B are each designing parameters for determining to what extent the prediction time period H is prolonged in accordance with the curvature κ. The relationship between the prediction time period H and the variable K is expressed by the equation (2) below.

$$H = \frac{{H}_{O}}{K} \qquad ( 2 )$$

In the equation (2), H0 is a preliminarily set prediction time period, which is a fixed value. In addition, each of the equations (1) and (2) is just an example; as long as the prediction time period H is prolonged when the curvature κ is large and the prediction time period H is shortened when the curvature κ is small, the equations for representing the relationship between the road curvature and the prediction time period are not limited to the equations (1) and (2). In the case of a complicated route, the curvature κ becomes large; however, because the prediction time period H is set by use of the equations (1) and (2), the prediction time period H can sufficiently be secured. In addition, the road curvature may be calculated without utilizing the target route T1. For example, the road curvature may be calculated by use of the respective positions in the vehicle-ahead direction and in the vehicle-transverse direction in a vehicle coordinate system. In this situation, in the vehicle coordinate system, the origin is the gravity center of the vehicle 40, and respective axes are defined in the longitudinal direction and in the transverse direction of the vehicle 40.

Next, the method in which the prediction time period setting section 422 sets a prediction time period, based on the target route T1 and the present values of the states of the vehicle 40, will be explained by use of FIG. 3.

FIG. 3 is an explanatory chart representing an example of a method of setting a predicted-amount lower limit value according to Embodiment 1. The predicted amount signifies a distance at a time when the states are predicted in a time period ranging from the present to the future; when the velocity of the vehicle 40 is constant, the predicted amount is in proportion to the prediction time period. Then, the prediction time period setting section 422 sets a predicted amount for predicting the states, in such a way that it falls between an upper limit value Lₘₐₓ to be calculated from the route length of the target route T1 and a preliminarily set lower limit value Lₘᵢₙ, and then sets the prediction time period based on this predicted amount. Specifically, the prediction time period setting section 422 sets the prediction time period, based on the predicted amount and the velocity of the vehicle 40.

FIG. 3 is an explanatory chart representing a case where the vehicle 40 travels in such a way as to make a U-turn along the target route T1. In this case, it is only necessary that as a predicted amount, the distance from the point at a time before the U-turn to the U-turn destination can be secured. In this regard, however, because the turning radius of a U-turn differs depending on the place, the minimal turning radius rₘᵢₙ of the vehicle 40 will be utilized here. That is to say, it is only necessary that the predicted-amount lower limit value Lₘᵢₙ is a semicircle having a radius of at least the minimal turning radius renin of the vehicle 40. The predicted-amount lower limit value Lₘᵢₙ is expressed by the equation (3) below.

Lₘᵢₙ=πrₘᵢₙ (3)

The prediction time period setting section 422 sets the predicted-amount lower limit value Lₘᵢₙ by use of the minimal turning radius renin of the vehicle 40. In addition, it may be allowed that the prediction time period setting section 422 does not set the predicted amount L in such a way that it falls between the upper limit value Lₘₐₓ and the lower limit value Lₘᵢₙ. In this case, the prediction time period H is set by use of the predicted-amount upper limit value Lₘₐₓ and the predicted-amount lower limit value Lₘᵢₙ. When this is taken into consideration, the prediction time period H is expressed by the equation (4) below.

$$H = \{ \begin{matrix}{L}_{min} / max ( V , {V}_{clip} ) , & L < {L}_{min} \\ L / max ( V , {V}_{clip} ) , & {L}_{min} \leq L < {L}_{max} \\ {L}_{max} / max ( V , {V}_{clip} ) , & L \geq {L}_{max}\end{matrix} \qquad ( 4 )$$

In the equation (4), V is the velocity of the vehicle 40, V_{clip} is the clipped value of the velocity of the vehicle 40. In the case where the route is complicated and hence the velocity of the vehicle 40 becomes extremely low, the prediction time period H becomes extremely long. In order to prevent this and in order to prevent the velocity from becoming below zero, the clip value V_{clip} is provided.

The prediction time period setting section 422 may calculate the predicted-amount upper limit value Lₘₐₓ, without depending on the route length of the target route T1. The prediction time period setting section 422 may calculate the upper limit value Lₘₐₓ, based on, for example, the sensing range of the external sensor 2.

The prediction time period setting section 422 may set the prediction time period H based on either the equations (1) and (2) explained by use of FIG. 2 or the equations (3) and (4) explained by use of FIG. 3. After setting the prediction time period H, the prediction time period setting section 422 sets the number of prediction points and a prediction interval. The number of prediction points are the number of points in a point sequence at a time when the states are predicted in a time period ranging from the present to the future. The prediction interval is the time interval of the point sequence. The number of prediction points and the prediction interval are utilized in the control calculation section 423. The relationship among the prediction time period H, the number of prediction points N, and the prediction interval dt is expressed by the equation (5) below.

H=N·dt (5)

As expressed in the equation (5), the prediction time period is the multiplication product of the number of prediction points and the prediction interval. The number of prediction points N and the prediction interval dt are set in such a way as to satisfy the equation (5) for the set prediction time period H. For example, it may be allowed either that the prediction interval dt is changed while the number of prediction points N is fixed or that the number of prediction points N is changed while the prediction interval dt is fixed. In addition, it may be allowed that both the number of prediction points N and the prediction interval dt are changed. For example, when the number of prediction points N is large, the calculation load at a time when the control calculation section 423 calculates the target control values becomes high. In contrast, when the prediction interval dt is long, the accuracy between the respective prediction points is deteriorated. Accordingly, the number of prediction points N and the prediction interval dt are changed in such a way that the balance between the calculation load and the accuracy is kept. As an example, the prediction time period H tends to become long when the route is complicated. When the prediction interval dt is prolonged while the number of prediction points N is fixed, the deviation from the actual route is caused between the respective prediction points. Accordingly, in such a case, the prediction interval dt is fixed and the number of prediction points N is increased. In this case, because although the calculation load becomes high, the high calculation load is limited to the case where the route is complicated, it is made possible to minimize the increase in the calculation load.

Next, the control calculation section 423 will be explained. The control calculation section 423 generates a point sequence for the target trajectory to be generated by the target-trajectory generation section 421. This point sequence starts from the present time point in the prediction time period H; the number of points in the point sequence is the number of prediction points N and the interval of the point sequence is the prediction interval dt. By use of the vehicle movement model, the control calculation section 423 predicts the states of the vehicle 40 at time points corresponding to the foregoing point sequence. The control calculation section 423 calculates the optimal target control values by solving, every constant period, an optimization problem for obtaining the control input amount that minimizes a specific evaluation function. The control calculation section 423 solves, every constant period, the constrained optimization problem expressed by the equation (6) below.

$${min}_{x , u} J s . t . \dot{x} = f ( x , u ) , {x}_{0} = x ( 0 ) , g ( x , u ) \leq 0 \qquad ( 6 )$$

In the equation (6), J is an evaluation function, u is a control input amount, x is the states of the vehicle 40, x₀ is an initial value, f is a vector function related to a vehicle movement model, g is a vector function related to constraints, and x′ is obtained through time differentiation of x. The initial value x₀ corresponds to the present values of the states of the vehicle 40 at t time point 0. The states x of the vehicle 40 and the control input amount u are defined by the following equations (7) and (8), respectively.

x=[X,Y,θ,β,γ,δ,V,a]^{T} (7)

u=[ω,J]^{T} (8)

In the equations (7) and (8), X and Y represent the gravity center position of the vehicle 40 in an inertial coordinate system, θ is a yaw angle, β is a sideslip angle, γ is a yaw rate, δ is a steering angle, a is acceleration, co is a steering-angle velocity, and J is a jerk degree. In the equations (7) and (8), the states x of the vehicle 40 and the control input amount u are each column vectors; for the sake of simplicity, transposed matrixes are utilized therefor. As the vehicle movement model utilizing the variables in the equations (7) and (8), a two-wheel model expressed by the equation (9) below is utilized.

$$\dot{x} = f ( x , u ) = \vert \begin{matrix}\begin{matrix}\begin{matrix}\begin{matrix}\begin{matrix}\begin{matrix}\begin{matrix}V cos ( θ + β ) \\ V sin ( θ + β )\end{matrix} \\ γ\end{matrix} \\ - ( 1 + \frac{2 ( {K}_{f} {L}_{f} - {K}_{r} {L}_{r} )}{{MV}^{2}} ) γ - \frac{2}{MV} ( {K}_{f} + {K}_{r} ) β + \frac{2 K}{MV} δ\end{matrix} \\ - \frac{2}{IV} ( {K}_{f} {L}_{f}^{2} + {K}_{r} {L}_{r}^{2} ) γ - \frac{2}{I} ( {K}_{f} {L}_{f} - {K}_{r} {L}_{r} ) β + \frac{2}{I} {K}_{f} {L}_{f} δ\end{matrix} \\ ω\end{matrix} \\ a\end{matrix} \\ J\end{matrix} \vert \qquad ( 9 )$$

In the equation (9), I is the yaw inertia moment of the vehicle 40, M is the mass of the vehicle 40, K_{f} is the cornering stiffness of the front wheel, Kᵣ is the cornering stiffness of the rear wheel, L_{f} is the distance between the gravity center of the vehicle 40 and the front wheel, and Lᵣ is the distance between the gravity center of the vehicle 40 and the rear wheel.

In the present embodiment, the optimization problem in the equation (6) is dealt with as a minimization problem; however, the optimization problem can be dealt with as a maximization problem by inverting the signs of the evaluation function J. As the evaluation function J, the equation (10) below is utilized.

$$J = {( {h}_{N} ( {x}_{N} ) - {r}_{N} )}^{T} {W}_{N} ( {h}_{N} ( {x}_{N} ) - {r}_{N} ) + {\sum }_{k = 0}^{N - 1} {( h ( {x}_{k} , {u}_{k} ) - {r}_{k} )}^{T} W ( h ( {x}_{k} , {u}_{k} ) - {r}_{k} ) \qquad ( 10 )$$

In the equation (10), k is a prediction point taking a value from 0 to the number of prediction points N; N is a terminal point. Xₖ is the states of the vehicle 40 at the prediction point k, uₖ is the control input amount at the prediction point k, h is a vector function related to an evaluation item, h_{N} is a vector function related to an evaluation item at the terminal point, rₖ is a target value at the prediction point k, r_{N} is a target value at the terminal point, W is a diagonal matrix whose diagonal components have respective weights for evaluation items at the prediction point k, and W_{N} is a diagonal matrix whose diagonal components have respective weights for evaluation items at the terminal point. Each of the matrixes W and W_{N} can appropriately be changed, as a parameter. The vector functions h and h N related to evaluation items are set as expressed in the following equations (11) and (12), respectively.

h=[e_{X,k},e_{Y,k},e_{θ,k},e_{V,k},ωₖ,jₖ]^{T} (11)

h_{N}=[e_{X,N},e_{Y,N},e_{θ,N},e_{V,N}]^{T} (12)

In the equation (11), each of e_{X,k} and e_{Y,k} is a tracking error with respect to the target route T1 at the prediction point k. In the equation (11), e_{θ,k} is a tracking error with respect to the target yaw angle at the prediction point k, and e_{V,k} is a tracking error with respect to the target vehicle velocity at the prediction point k. In the equation (11), ωₖ is the steering-angle velocity at the prediction point k; jₖ is the jerk degree at the prediction point k. In the equation (12), each of e_{X,N} and e_{Y,N} is a tracking error with respect to the target route T1 at the prediction point N. In the equation (12), e_{θ,N} is a tracking error with respect to the target yaw angle at the prediction point N, and e_{V,N} is a tracking error with respect to the target vehicle velocity at the prediction point N. The tracking errors e_{X,k}, e_{Y,k}, e_{θ,k}, and e_{V,k} are expressed by the following equations (13), (14), (15), (16), respectively.

e_{X,k}=(Xₖ−X_{tg,k})cos θ_{tg,k}−(Yₖ−Y_{tg,k})sin θ_{tg,k} (13)

e_{Y,k}=(Xₖ−X_{tg,k})sin θ_{tg,k}−(Yₖ−Y_{tg,k})cos θ_{tg,k} (14)

e_{θ,k}=θₖ−θ_{tg,k} (15)

e_{V,k}=Vₖ−V_{tg,k} (16)

In the equations (13) through (16), each of Xₖ and Yₖ is the gravity center position of the vehicle 40 at the prediction point k, each of X_{tg,k} and Y_{tg,k} is the target vehicle-gravity-center position at the prediction point k, θₖ is the yaw angle at the prediction point k, Vₖ is the velocity of the vehicle 40 at the prediction point k, θ_{tg,k} is the target yaw angle at the prediction point k, and V_{tg,k} is the target vehicle velocity at the prediction point k. The target values rₖ and r_{N} are set as expressed by the following equations (17) and (18), respectively, so that the tracking errors expressed in the equations (13) through (16), the steering-angle velocity ωₖ, and the jerk degree jₖ are reduced.

rₖ=[0,0,0,0,0,0]^{T} (k=0, . . . ,N−1) (17)

r_{N}=[0,0,0,0]^{T} (18)

In the present embodiment, the tracking errors expressed in the equations (13) through (16), the steering-angle velocity ωₖ, and the jerk degree jₖ are set so as to be evaluated; however, it may be allowed that in order to raise the riding comfort of the vehicle 40, the acceleration a, the yaw rate γ, and the like are added to the evaluation items.

The vector function g is to set the respective upper/lower limit values of the states x of the vehicle 40 and the control input amount u in a constrained optimization problem; the optimization is performed under the condition that g (x,u)≤0. The vector function g is set as expressed by the equation (19) below.

$$g = [ \begin{matrix}ω - {ω}_{max} \\ - ω + {ω}_{min} \\ j - {j}_{max} \\ - j + {j}_{min}\end{matrix} ] \qquad ( 19 )$$

In the equation (19), ωₘₐₓ and ωₘᵢₙ is the upper limit value and the lower limit value, respectively, of the steering-angle velocity. In the equation (19), jₘₐₓ and jₘᵢₙ are the upper limit value and the lower limit value, respectively, of the jerk degree. Setting of the upper limit values and the lower limit values makes it possible to perform vehicle control for securing the riding comfort of the vehicle 40. In addition, it may be allowed either that in order to further raise the riding comfort, the respective upper and lower limit values are set for the acceleration a, the yaw rate γ, and the like or that in order to strictly observe the speed limit, the upper and lower limit values are set also for the velocity V of the vehicle 40.

In addition, the control calculation section 423 may adjust the weights of the evaluation function J at a time when the target control values are calculated, based on the prediction time period H. That is to say, based on the prediction time period H, the matrixes W and W_{N} in the equation (10) are adjusted. As an example, the adjusted matrixes W_{adj} and W_{adj,N} are expressed by the following equations (20) and (21), respectively.

$${W}_{adj} = \frac{W}{{scale}^{2}} \qquad ( 20 )$$

$${W}_{adj , N} = \frac{{W}_{N}}{{scale}^{2}} \qquad ( 21 )$$

In the equations (20) and (21), “scale” is the changing rate of the prediction interval dt and is expressed by the equation (22) below.

$$scale = \frac{dr}{{dt}_{o}} \qquad ( 22 )$$

In the equation (22), dt₀ is a preliminarily set prediction interval. As represented in the equations (20) through (22), the matrixes W_{adj} and W_{adj,N} are adjusted by use of the prediction interval dt; however, the matrixes W_{adj} and W_{adj,N} may be adjusted by use of the prediction time period H. Because the weights of the states can be set in accordance with the prediction time period H, by adjusting the matrixes W_{adj} and W_{adj,N}, the calculation results can be suppressed from changing suddenly due to a change in the prediction time period H.

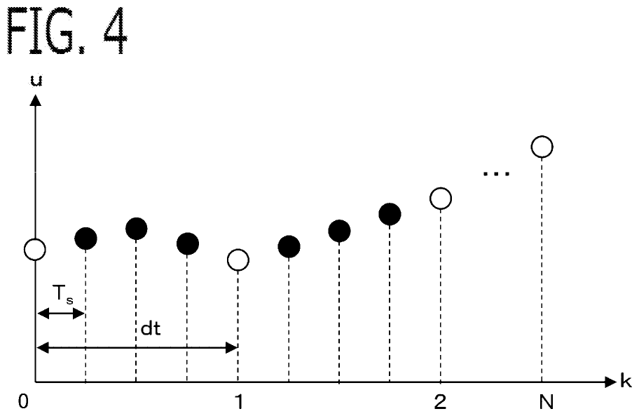

In addition, each of the calculation period for the optimization problem in the equation (6) and the calculation period for the target control values is the prediction interval dt and changes depending on the route. Instead of that, it may be allowed that the control calculation section 423 calculates the optimization problem with the prediction interval dt by use of dt₀ and the target control values by use of a constant period Tₛ. In this situation, dt₀ is a preliminarily set prediction interval and is a fixed value. FIG. 4 is a graph representing an example of the relationship between the target-control-value calculation period Tₛ and the prediction interval dt according to Embodiment 1. In this case, in the optimization problem expressed by the equation (6), the optimal vehicle states x are obtained at each of N points, through the control input amount u for which a first-order hold is assumed. Accordingly, a target steering amount δₒᵤₜ and a target acceleration/deceleration amount a out can be calculated in the period Ts, by use of the equations (23) and (24) below.

$${δ}_{out} = {δ}_{j} + \frac{i - ( dt / {T}_{s} ) \cdot j}{( dt / {T}_{s} )} ( {δ}_{j + 1} - {δ}_{j} ) \qquad ( 23 )$$

$$( i = 1 ∼ ceil ( {dt}_{0} / {T}_{s} ) , j = floor ( {iT}_{s} / dr ) )$$

$${a}_{out} = {a}_{j} + \frac{i - ( dt / {T}_{s} ) \cdot j}{( dt / {T}_{s} )} ( {a}_{j + 1} - {a}_{j} ) \qquad ( 24 )$$

$$( i = 1 ∼ ceil ( {dt}_{0} / {T}_{s} ) , j = floor ( {iT}_{s} / dt ) )$$

In the equations (23) and (24), “ceil” signifies rounding-up to the nearest integer; “floor” signifies rounding-down to the nearest integer. The character “i” signifies an integer that counts up by 1 every period Ts and is reset to 1 every dt₀. Because the control calculation section 423 calculates the target control values in the constant period Ts, the control period at a time when the vehicle 40 is controlled becomes constant; thus, smooth vehicle control can be realized.

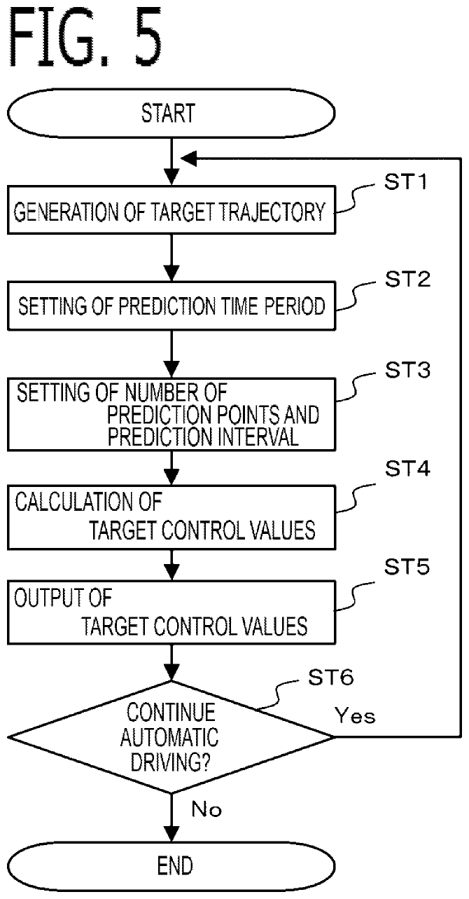

FIG. 5 is a flowchart representing an example of a procedure from target-trajectory generation to target-control-value outputting according to Embodiment 1. That is to say, FIG. 5 is a flowchart representing an example of a control calculation method according to Embodiment 1.

As represented in FIG. 5, when automatic driving is started through an unrepresented means, the target-trajectory generation section 421 generates a target trajectory including the target route T1 for the vehicle 40, based on information around the vehicle 40 (the step ST1).

Based on at least the target route T1, the prediction time period setting section 422 sets a prediction time period for predicting the states of the vehicle 40 (the step ST2).

The prediction time period setting section 422 sets the number of prediction points and the prediction interval, based on the prediction time period (the step ST3).

The control calculation section 423 calculates target control values for making the vehicle 40 keep track of the target trajectory in the prediction time period (the step ST4). That is to say, the control calculation section 423 calculates the target control values by solving the optimization problem expressed by the equation (6).

The control calculation section 423 outputs the target control values to the control section 5 (the step ST5). That is to say, the control calculation section 423 outputs the target steering amount to the steering actuator 51 in the control section 5 and outputs the target acceleration/deceleration amount to the driving actuator 52 in the control section 5.

Whether or not the automatic driving is to be continued is determined through an unrepresented means (the step ST6).

In the case where the determination in the step ST6 is “Yes”, the processing is followed by the step ST1, where the automatic driving is continued. In the case where the determination in the step ST6 is “No”, the automatic driving is ended. The case where the automatic driving is ended is, for example, a case where when it is determined that the vehicle 40 has deviated from the target route T1 and has abnormally traveled, the automatic driving is forcibly ended. In this case, processing of, for example, making the vehicle 40 temporarily stop on the spot is performed.

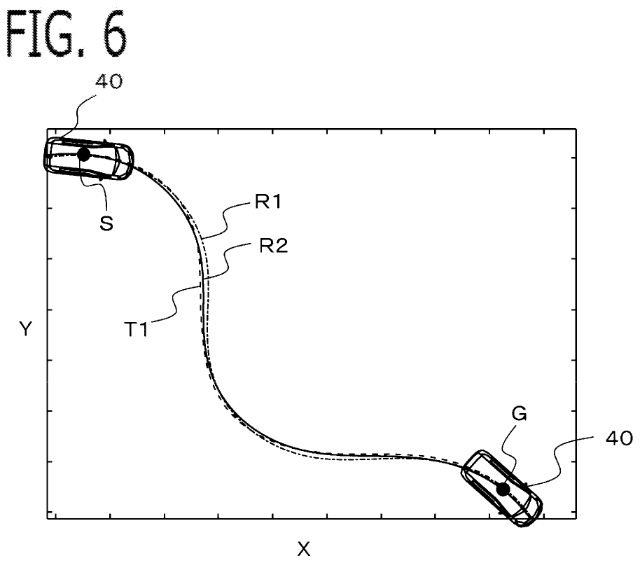

FIG. 6 is a simulation result representing an example of a traveling trajectory of the vehicle 40 for the target route T1 according to Embodiment 1. In FIG. 6, each of the abscissa X and the ordinate Y denotes the gravity center position of the vehicle 40 in an inertial coordinate system. The one-dot chain line R1 represents the traveling trajectory of the vehicle 40 at a time when the prediction time period H is a preliminarily set fixed value H₀. The solid line R2 is the traveling trajectory of the vehicle 40 at a time when the prediction time period H is set by use of the equation (4).

As illustrated in FIG. 6, the trackability at a time when the prediction time period H is set by use of the equation (4) (the solid line R2) is satisfactory, in comparison with the trackability at a time when the prediction time period H is the fixed value H₀ (the one-dot chain line R1). In addition, the solid line R2 and the one-dot chain line R1 are the same in terms of the number of prediction points N but are different from each other in terms of the prediction interval dt. That is to say, the both cases have the same calculation load at a time when the target control values are calculated.

Because in Embodiment 1 explained above, the prediction time period is set based on the target route T1, the predicted amount can sufficiently be secured even in the case of a complicated route; thus, the target control values can accurately be calculated.

### Embodiment 2

In Embodiment 2, based on the error between the target trajectory and an approximate target trajectory obtained by approximating the target trajectory with a polynomial, the number of prediction points N and the prediction interval dt are set.

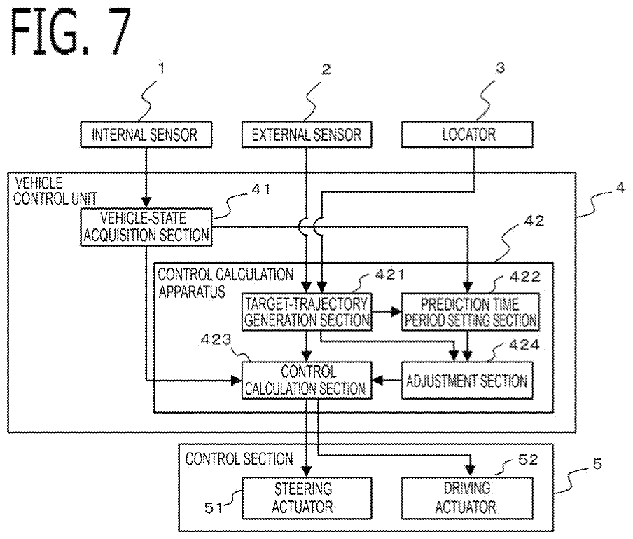

FIG. 7 is a block diagram representing an example of the control calculation apparatus 42. FIG. 7 is different from FIG. 1 in that an adjustment section 424 is provided therein. Because the members other than the adjustment section 424 are the same as those in FIG. 1, the explanations therefor will be omitted.

The adjustment section 424 generates an approximate target trajectory obtained by sampling the target trajectory from the target-trajectory generation section 421 in a period corresponding to the prediction interval dt to be set by the prediction time period setting section 422 and approximating the target trajectory with a polynomial. The adjustment section 424 adjusts the number of prediction points N and the prediction interval dt so that the error between the target trajectory from the target-trajectory generation section 421 and the approximate target trajectory falls within a predetermined range. When in the case of a complicated route, the prediction time period H is prolonged, there is a method in which in order to suppress the calculation load at a time when the target control values are calculated, the prediction interval dt is expanded without changing the number of prediction points N. However, in this case, a deviation between the actual target trajectory and an approximate target route is caused between respective prediction points. Accordingly, the adjustment section 424 evaluates the error between the target trajectory and the approximate target trajectory and then adjusts the number of prediction points N and the prediction interval dt, based on the evaluation. This method makes it possible that while the error from the actual target trajectory is suppressed, it is least required to increase the number of prediction points N; thus, the calculation load can be suppressed. In addition, the subjects to be each approximated with a polynomial include the target route T1, the target velocity, and the like in the target trajectory; however, only any one thereof may be approximated with a polynomial. In addition, two of the target route T1, the target velocity, and the like may be each approximated with a polynomial. For example, in the case where the target route T1 and the target velocity are each approximated with a polynomial, both the error between the target route T1 and the approximate target route and the error between the target velocity and an approximate target velocity are considered.

The control calculation section 423 calculates the target control values, by use of the number of prediction points N and the prediction interval dt adjusted by the adjustment section 424.

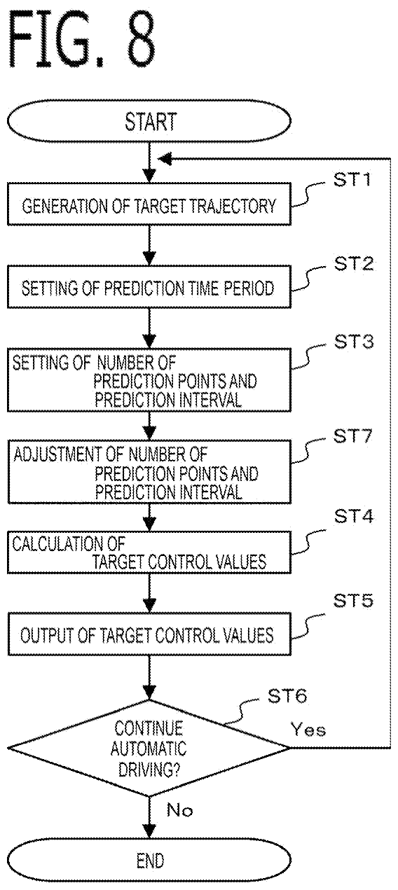

FIG. 8 is a flowchart representing an example of a procedure from target-trajectory generation to target-control-value outputting according to Embodiment 2. That is to say, FIG. 4 is a flowchart representing an example of a control calculation method according to Embodiment 1. The steps ST1 through ST6 in FIG. 8 are the same as the steps ST1 through ST6 in FIG. 4; thus, the explanations therefor will be omitted.

As represented in FIG. 8, when automatic driving is started through an unrepresented means, the target-trajectory generation section 421 generates a target trajectory including the target route T1 for the vehicle 40, based on information around the vehicle 40 (the step ST1).

Based on at least the target route T1, the prediction time period setting section 422 sets a prediction time period for predicting the states of the vehicle 40 (the step ST2).

The prediction time period setting section 422 sets the number of prediction points and the prediction interval, based on the prediction time period (the step ST3).

The adjustment section 424 adjusts the number of prediction points N and the prediction interval dt, based on the error between the target trajectory from the target-trajectory generation section 421 and the approximate target trajectory obtained by approximating the target trajectory with a polynomial (the step ST7).

The control calculation section 423 calculates the target control values for making the vehicle 40 keep track of the target trajectory in the prediction time period (the step ST4).

The control calculation section 423 outputs the target control values to the control section 5 (the step ST5).

Whether or not the automatic driving is to be continued is determined through an unrepresented means (the step ST6).

In the case where the determination in the step ST6 is “Yes”, the processing is followed by the step ST1, where the automatic driving is continued. In the case where the determination in the step ST6 is “No”, the automatic driving is ended.

In Embodiment 2 explained above, the adjustment section 424 adjusts the number of prediction points and the prediction interval, based on the error between the target trajectory from the target-trajectory generation section 421 and the approximate target trajectory obtained by approximating the target trajectory with a polynomial. This method makes it possible that while the error from the actual target trajectory is suppressed, it is least required to change the number of prediction points; thus, the calculation load can be suppressed from increasing.

In this situation, there will be explained the hardware configuration of each of the vehicle-state acquisition section 41, the control calculation apparatus 42, and the control section 5 according to any one of Embodiments 1 and 2. The respective functions of the vehicle-state acquisition section 41, the control calculation apparatus 42, and the control section 5 are each realized by a processing circuit. The processing circuit has at least one processor and at least one memory.

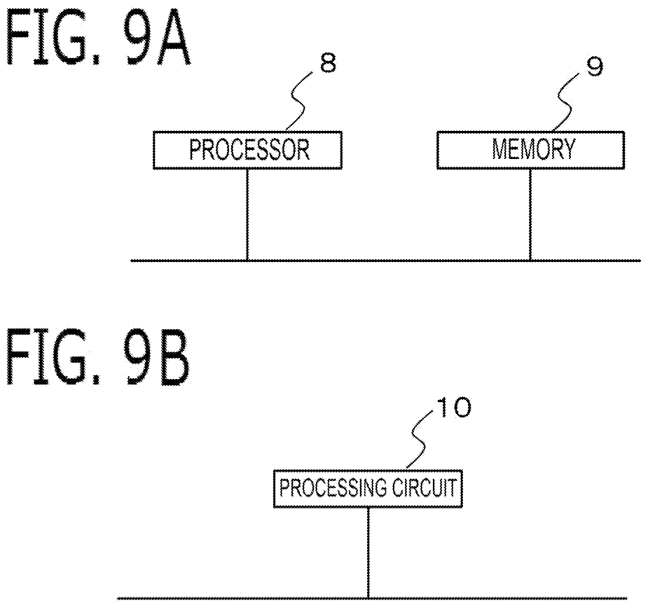

FIG. 9 is a diagram representing the hardware configuration of each of the vehicle-state acquisition section 41, the control calculation apparatus 42, and the control section 5 according to any one of Embodiments 1 and 2. The vehicle-state acquisition section 41, the control calculation apparatus 42, and the control section 5 are each realized by a processor 8 and a memory 9 represented in FIG. 9(a). The processor 8 is, for example, a CPU (Central Processing Unit, referred to also as a processing apparatus, a calculation apparatus, a microprocessor, a microcomputer, a processor, or a DSP (Digital Signal Processor)) or a system LSI (Large Scale Integration).

The memory 9 is, for example, a nonvolatile or volatile semiconductor memory such as a RAM (Random Access Memory), a ROM (Read Only Memory), a flash memory, an EPROM (Erasable Programmable Read Only Memory), or an EEPROM (Electrically Erasable Programmable Read-Only Memory, a registered trademark), an HDD (Hard Disk Drive), a magnetic disk, a flexible disk, an optical disk, a compact disk, a mini disk, or a DVD (Digital Versatile Disk).

The respective functions of the vehicle-state acquisition section 41, the control calculation apparatus 42, and the control section 5 are each realized by software or firmware, or by software and firmware. The software and the like are described as programs and are stored in the memory 9. The processor 8 reads and executes the program stored in the memory 9 so as to realize the function of each of the respective sections. In other words, this program is to make the computer execute the procedure or the method of each of the vehicle-state acquisition section 41, the control calculation apparatus 42, and the control section 5.

It may be allowed that the program to be executed by the processor 8 is an installable-type file or an executable-type file, stored in a storage medium that can be read by the computer, and provided as a computer program product. Moreover, it may be allowed that the respective programs to be executed by the processor 8 are provided to the vehicle-state acquisition section 41, the control calculation apparatus 42, and the control section 5, through a network such as the Internet.

In addition, it may be allowed that the vehicle-state acquisition section 41, the control calculation apparatus 42, and the control section 5 are each realized by a dedicated processing circuit 10 represented in FIG. 9(b). In the case where the processing circuit 10 is dedicated hardware, the processing circuit 10 falls under the category of, for example, a single circuit, a composite circuit, a programmed processor, an in-parallel programmed processor, an ASIC (Application Specific Integrated Circuit), or an FPGA (Field-Programmable Gate Array) or a combination of these items.

Heretofore, there has been explained a configuration in which the respective functions of the vehicle-state acquisition section 41, the control calculation apparatus 42, and the control section 5 are each realized by either software or the like or hardware. However, the configuration is not limited thereto; it may be allowed that the configuration of part of the vehicle-state acquisition section 41, the control calculation apparatus 42, and the control section 5 is realized by software or the like and the other part thereof is realized by dedicated hardware.

### REFERENCE SIGNS LIST

1: internal sensor
2: external sensor
3: locator
4: vehicle control unit
40: vehicle
41: vehicle-state acquisition section
42: control calculation apparatus
421: target-trajectory generation section
422: prediction time period setting section
423: control calculation section
424: adjustment section
5: control section
51: steering actuator
52: driving actuator
8: processor
9: memory
10: processing circuit
T1: target route

1. A control calculation apparatus comprising at least one processor configured to implement:
a target-trajectory generator that generates a target trajectory including a target route for a vehicle, based on information around the vehicle;
a prediction time period setter that sets a prediction time period for predicting states of the vehicle, based on the target route; and
a control calculator that calculates target control values for making the vehicle keep track of the target trajectory in the prediction time period, and then outputs the target control values to a controller that controls the vehicle.

2. The control calculation apparatus according to claim 1, wherein the prediction time period setter sets the prediction time period, based on the target route and present values of the states.

3. The control calculation apparatus according to claim 2, wherein the prediction time period setter sets the prediction time period, based on the target route and a present value of velocity in the states.

4. The control calculation apparatus according to claim 1, wherein the prediction time period setter sets a predicted amount for predicting each of the states, in such a way that the predicted amount falls between an upper limit value to be calculated from a route length of the target route and a preliminarily set lower limit value, and then sets the prediction time period based on the predicted amount.

5. The control calculation apparatus according to claim 4, wherein the prediction time period setter sets the lower limit value, by use of a minimal turning radius of the vehicle.

6. The control calculation apparatus according to claim 1, wherein the prediction time period setter sets the prediction time period, based on a road curvature to be calculated from the target route.

7. The control calculation apparatus according to claim 1, wherein the prediction time period is a multiplication product of the number of prediction points and a prediction interval.

8. The control calculation apparatus according to claim 7, further comprising an adjuster that generates an approximate target trajectory by sampling the target trajectory in a period corresponding to the prediction interval and approximating the target trajectory with a polynomial and that adjusts the number of prediction points and the prediction interval so that an error between the target trajectory and the approximate target trajectory falls within a predetermined range.

9. The control calculation apparatus according to claim 1, wherein the control calculator adjusts weights of an evaluation function at a time when the target control values are calculated, based on the prediction time period.

10. The control calculation apparatus according to claim 1, wherein the control calculator calculates the target control values in a constant period and then outputs the target control values.

11. A control calculation method comprising:
generating a target trajectory including a target route for a vehicle, based on information around the vehicle;
setting a prediction time period for predicting states of the vehicle, based on the target route; and
calculating target control values for making the vehicle keep track of the target trajectory in the prediction time period and then outputting the target control values to a controller that controls the vehicle.
